(19) United States
(12) Patent Application Publication
(10) Pub. No.: US 2003/0115783 A1
(43) Pub. Date: Jun. 26, 2003

(54) Combined floor drier and caution sing

(76) Inventor: Kregg D. Woosley, Cedar Hill, TN (US)

Correspondence Address: David W. Carrithers, CARRITHERS LAW OFFICE, One Paragon Centre, 6060 Dutchman's Lane, Suite 140, Louisville, KY, 40205, US

(21) Appl. No.: 10/035,784

(22) Filed: Dec. 26, 2001

(51) Int. Cl. G09F 7/00

(52) U.S. Cl. 40/584; 40/610

(57) ABSTRACT

A portable wet floor powered drier and attention getting warning devise that includes a power driven fan mounted on the lower end of housing and having a chute directing the flow of air therefrom in a curtain along the adjacent wet floor surface. Audible and/or visual signaling devices can be mounted on the device and can be activated by a motion sensor and the circuits therefore may include timer, delay and/or sequencing switches.

### FIELD OF INVENTION

This invention relates in general to reducing slips and falls on wet floors and more particularly to a portable pro-active caution sign to be placed near a wet floor area to warn pedestrians of the hazard and at the same time reduce the drying time by causing air to flow along the surface of the wet floor.

### BACKGROUND OF INVENTION

Floors that are wet, following a cleaning or due to spills, pose a safety hazard for pedestrians and give rise every year to numerous law suits and resulting potential major liabilities for the building owners and/or operators. Reasonable precautions are normally exercised by placement of portable passive caution signs in the general vicinity of the wet floor but these have become so common place that there are often unnoticed or ignored. Also, seldom or ever does one see any efforts made to reduce the drying time and never a sign that pro-actively warns those in the vicinity of the impending danger. The evaporation of moisture can be expedited by increasing air flow in the area of concern. U.S. Design Pat. No. 328,615 granted Aug. 11, 1992 to Joe E. Taylor teaches a combined portable floor sign and fan presumably intended for that purpose; however, the design does not proactively communicate to customers the danger such as by light or sound signals.

### SUMMARY OF INVENTION

In keeping with the foregoing there is provided a wet floor cautioning device comprising a housing that includes a base floor panel, and at least a pair of side panels each connected at a lower end thereof to the base floor panel and interconnected at their opposite upper ends. An open window in at least one of the side panels adjacent the interconnection thereof providing a handle means for carrying the device. At least one power driven fan unit is mounted on and located within the housing. The fan unit may be powered from and electrical socket source or by a battery pack and has at least one air discharge chute disposed adjacent or in close proximity to the base floor panel directing air flowing from the fan in a curtain along the surface of a floor on which the base floor panel is resting. Moreover, one or more ventilation slits may be formed in the base floor panel as well. Pro-active attention getting devices such as lights, a lighted display or audible warning device can be mounted on the housing for generating at least one an audible and/or a visual signal. Furthermore a motion sensor/detector may be used to activate the pro-active device(s) in response to the motion of a pedestrian in the vicinity of said device. A timer or moisture detection device may also be incorporated within the device. Warning indicia as well as hazard type color markings may be incorporated therewith. An adhesive strip may be used to removably secure the housing to a floor surface or castors may be used to provide ease of movement across the floor.

An object of the present invention is to provide a portable floor stand with a power driven fan so located and with a discharge chute such that air from the fan is caused to flow as a curtain along the floor surface and further where such stand has pro-active attention getting enhancements to warn pedestrians of the potential danger.

The foregoing and other objects and advantages of the invention will be set forth in or apparent from the following description.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is an oblique view of the portable stand and floor drying unit of the present invention showing the fan unit;

FIG. 2 is an oblique view of the portable stand and floor drying unit of FIG. 1 showing louvers for directing air currents;

FIG. 3 is an oblique view of an alternate embodiment of the portable stand and floor drying unit without casters;

FIG. 4 is a side view showing an alternate streamlined embodiment of the portable stand and floor drying unit;

FIG. 5 is a front view showing the embodiment of FIG. 4; and

FIG. 6 is a rear view showing the embodiment of FIG. 4.

### DESCRIPTION OF THE PREFERRED EMBODIMENTS

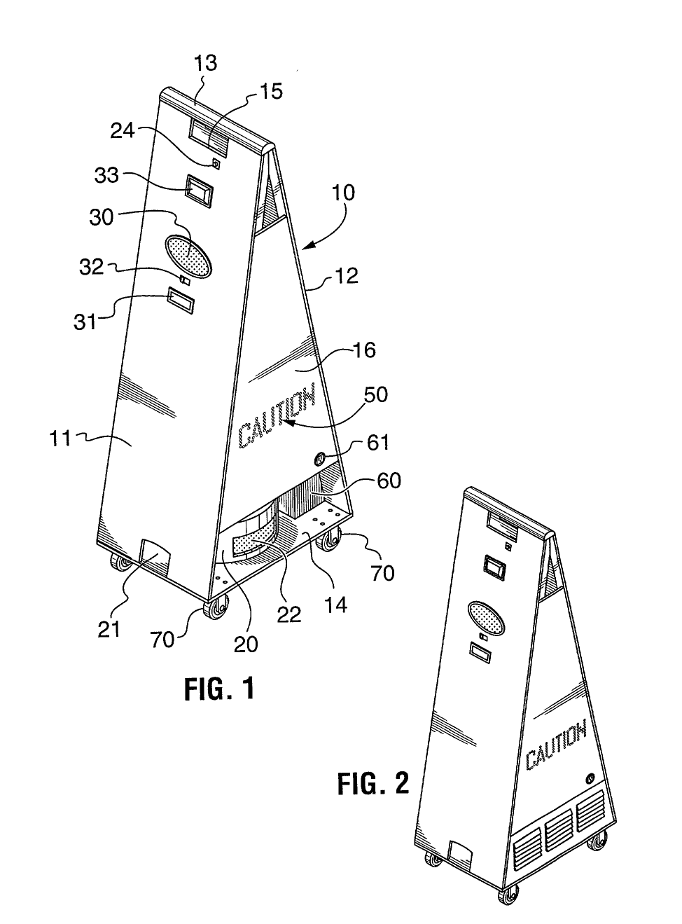

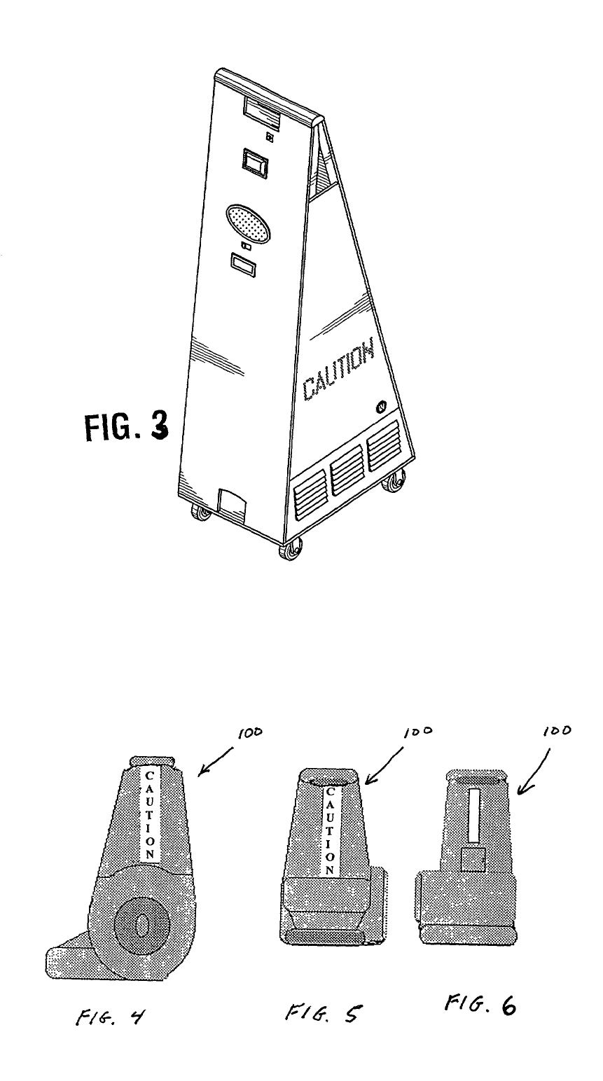

As shown in FIGS. 1-3, the portable stand unit of the present invention includes a housing 10 consisting of a frame covered with panels, or rigid panels cooperatively connected to one another to form a frame and housing. At least one power driven fan unit 20 is mounted on the lower portion of the frame and powered by a battery which can be rechargeable or a cord plugged into an electrical receptacle. The fan unit has a flow directing housing 21 that directs the flow of air therefrom as a curtain along the surface of the floor supporting the unit thereby minimizing power requirements to move the air. This is important because of the fan preferably being battery powered. The frame and housing is preferably made of light weight rigid plastic; however, metal, fiberglass, and/or other composite materials may be utilized to fabricate the frame and housing.

The housing is composed of a plurality of side panels 11 and 12 interconnected at their upper end as indicated by the reference 13 and the opposite ends thereof are connected in spaced apart relation to a base floor panel 14. Preferably an opposing pair of panels form the sidewalls of the housing; however, three panels could also be used effectively forming a pyramidal structure. The lower ends of the respective panel 11 and 12 are wider than their upper respective ends. However, this design is a matter of choice for the housing could also be formed in the shape of a rectangle, square or other shape. The panels are utilized to improve the directional flow of the air produced by the fan and could be used to enclose the fan device separate from or in the bottom of the frame. The panel(s) can have openings along the bottom for the fan air exhaust and/or in the floor and/or base. Louvers can be inserted within the openings in the housing or base to direct the air flow or a cooperative sliding blind can be utilized to open or shut selected openings and be used to direct the air flow. The panels extending to the top of the frame provides a support structure and protective enclosure for warning and communication devices, power sources, and electrical connections. Signage which may be attached via adhesive, static charge, ink, tape, screws, hook and loop magnets, or small tabs or flanges for holding placard. Messages such as “WARNING”, “WET FLOOR”, “SLIPPERY SURFACE”, or the like can also be displayed by lights such as LED lights. These side panel(s) can have thereon visual and audible attention getting devices such as a synthesized voice, speaker or alarm 30 of an audible generating device which may be switched on or off manually, controlled by a timer, or actuated by a motion sensor 31. Of course the light devices, sound devices, and/or combinations thereof can include a deactivating on/off switch 32. A preferred embodiment includes a caution blinking light 33 on at one least panel 11. Adjacent the juncture of the panels 13 there can be an opening forming at least one window 15 in selected panel(s) providing a handle used to carry the unit from one location to another.

As set forth heretofore, a preferred embodiment defines a housing having triangular side panels 16 spaced at their respective upper and lower opposite ends from the apex 13 of the side sloping panel and the base floor panel 14. The openings permit the flow of air to the intake 22 of the fan unit 20 which preferably is a squirrel cage fan. One of more slots may also be formed in the panels to pull air through the housing to the fan. The fan intake and exhaust can be covered by a protective cover consisting of a screen, slotted plate or the like to prevent insertion of debris therein and prevent children from poking their fingers or other objects into the fan unit. At least one panel can have light emitting diodes thereon as for example indicated at 50 where they are arranged to spell the warning word “CAUTION”. The fan unit is can be powered by a rechargeable battery 60 (of appropriate voltage, such as a 12 volt rechargeable battery) anchored in any suitable manner for example on the base panel 14. The selected fan will force air over a selected area of between 10 and 20 square feet depending upon whether all of the vents are open or some are closed and selected vents open to direct the flow of are and increase the velocity thereof. The battery can be charged by plugging the cord therefrom into a quick connect coupling 61 mounted on the side panel 16. If desired the fan unit can be connected to an electrical outlet in the building in cases where it needs to operate for long periods of time. The motor thus is preferably AC/DC and adapted to operate for example on 12VDC or 110VAC. Power to the motor of the fan unit is through an on/off switch 24. As shown in the drawings a preferred embodiment is shown with the fan motor and battery installed supported by the base plate so that the weight is maximized on the bottom of the unit providing a more stable unit which is difficult to tip over.

The entire unit is preferably light in weight so that it can be easily carried from one location of use to another but with heavier units, that maybe more appropriate for some tasks, the housing may be mounted, for example, on appropriately spaced apart wheel units or casters 70 one or more of which should be releasably lockable. The casters can be removable. Legs may also be substituted for the castors and be used for placing the unit onto the wet surface or area which is anticipated to be wet.

The motion sensor 31 maybe used not only to activate the audible generating device but also at least one of the blinking light 33 and the LED sign 50. Also the circuit for these can include timer switches and/delay circuits and/sequencing switches whereby they are activated for selected periods of time and/or in various and different sequences that maybe desired.

Selected panels may also be hinged at the edges in order for the housing to be collapsed for transport or storage. The hinges may be formed of plastic such as by “living hinges”, pin hinges or any other type of hinge. The panels may also be interlocking and secured by friction fit, snap fit, hook and loop fasteners or even tongue and groove engagement. The bottom base plate support member can be hinged or can be removably attached to the housing by screws or any other selected means of attachment and be removable for servicing or repair or replacement of battery, fan, or heater, units.

A small heater can be installed within the housing in fluid communication with the fan in order to further increase the effective drying rate of the unit.

Rubber or plastic isolation units can be utilized to reduce, vibration, provide insulation and securely hold the power units within the housing.

The on/off switch can be a single pole/single throw, single pole/double throw or other design and be placed anywhere on the housing. The unit may include a computer or simple microprocessor which to turn the fan, light, heater, or speaker on or off, control the speed, increase or decrease parameters, and program sequence of events. An small camera may also be installed to provide an image to a video recorder or live screen for recording. A keypad may be mounted to the housing and/or an infrared sensor or other device may be included providing means for activation and control by a remote control hand unit.

As illustrated in FIGS. 4-6, an alternate embodiment of a combined floor drier and caution sign comprises a portable unit whereby the panels are streamlined and a nozzle discharges air along the floor surface in a selected direction.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. A wet floor cautioning device comprising:
a housing comprising a base floor panel and a frame;
said frame comprising at least a pair of panels each connected at a lower end thereof to said base floor panel and interconnected at their opposite upper end;
at least one of said at least a pair of side panels including an opening; and
an electrically power driven fan unit mounted within and entirely enclosed within said housing, said fan unit having an air intake port and at least one discharge chute directing air flowing from the fan in a curtain along the surface of a floor.

2. The wet floor cautioning device of claim 1, including at least one pro-active attention getting device mounted on said housing.

3. The wet floor cautioning device of claim 2, wherein said pro-active attention getting device comprises at least one of the group consisting of at least one audible signal, at least one visible signal, at least one lighted visible signal.

4. The wet floor cautioning device of claim 2, said proactive attention getting device activating in response to motion of a pedestrian in the vicinity of said device.

5. The wet floor cautioning device of claim 1, wherein said fan is disposed adjacent said base floor panel.

6. The wet floor cautioning device of claim 1 including a handle.

7. The wet floor cautioning device of claim 2, wherein said handle comprises at least one panel having an opening formed therein.

8. The wet floor cautioning device of claim 1, wherein said fan is battery powered.

9. The wet floor cautioning device of claim 1, including a heating unit in fluid communication with said fan.

10. The wet floor cautioning device of claim 1, wherein said housing comprises at least three panels having side edges connecting to one another and bottom edges attaching to said base floor panel.

11. The wet floor cautioning device of claim 1, wherein said housing comprises at least four panels having side edges connecting to one another and bottom edges attaching to said base floor panel.

12. The wet floor cautioning device of claim 1, wherein said housing is collapsible and said side panels are hinged to one another by means for hinging.

13. The wet floor cautioning device of claim 1, wherein said means for hinging comprises a living hinge, a pin hinge, hook and loop fasteners, a snap fit or a tongue and groove arrangement.

14. The wet floor cautioning device of claim 1, including a camera for transmitting visual images to a recorder or video screen.

15. The wet floor cautioning device of claim 1, including a microprocessor for programming said fan, said pro-active device, or for programming parameters for controlling said devices.

16. The wet floor cautioning device of claim 1, including louvers within said housing to direct the flow of air from the fan.

17. The wet floor cautioning device of claim 1, including casters with at least one lockable wheel.

18. The wet floor cautioning device of claim 1, including feet extending from the bottom of said base floor panel.

19. The wet floor cautioning device of claim 1, wherein said pro-active attention getting devices include at least of a sound generating device, a visual signal and circuit means having at least one of timer, delay and sequencing switches.

20. The wet floor cautioning device of claim 1, wherein said bottom floor panel is removably connected to said at least two side panels.
